(19) United States
(12) Patent Application Publication
(10) Pub. No.: US 2010/0079587 A1
(43) Pub. Date: Apr. 1, 2010

(54) ENDOSCOPE SYSTEM

(75) Inventor: Koji YOSHIDA, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Fujifilm Corporation, Toyko (JP)

(21) Appl. No.: 12/569,702

(22) Filed: Sep. 29, 2009

(30) Foreign Application Priority Data
Sep. 30, 2008 (JP) JP2008-252343

(51) Int. Cl. H04N 7/18

(52) U.S. Cl. 348/68

(57) ABSTRACT

A small diameter of an endoscope is maintained, and both normal imaging with a visible light and fluorescence imaging can be performed. An endoscope system is provided in which a plurality of imaging devices that detect a reflected light of an illumination light reflected by a somatoscopy part or an emitted light emitted by the somatoscopy part are arranged in series in a distal end portion of an endoscope, each of the plurality of imaging devices includes a light splitting device that deflects 90° a part of the reflected light or the emitted light and transmits a part of the reflected light or the emitted light and an image pickup device that detects the reflected light or the emitted light deflected 90°, a rearmost imaging device includes an optical path changing device that deflects 90° the reflected light or the emitted light and an image pickup device that detects the reflected light or the emitted light deflected 90°, and an observation optical member is provided in which the light splitting device and the optical path changing device are arranged in series.

### BACKGROUND OF THE INVENTION

1. Field of the Invention

The present invention relates to an endoscope system, and more particularly to an endoscope system that performs both normal imaging in normal endoscopic observation with a visible light and fluorescence imaging in special light observation with an infrared light or the like in diagnosis or treatment (surgery) using an endoscope (rigid endoscope or flexible endoscope) for humans and animals.

2. Description of the Related Art

Conventionally, an endoscope device (endoscope system) has been widely used in medical fields. The endoscope device is used for inserting an elongated insertion portion into a body cavity to observe an object to be observed such as an organ in the body cavity, or inserting a treatment instrument through a hole (forceps opening) provided in the insertion portion to perform various kinds of treatment.

For inserting the insertion portion into the body cavity to observe the object to be observed, the endoscope device requires an illumination device that illuminates the object to be observed. If a normal white light source is used as an illumination light source at this time, a light is reflected by only a surface of the object to be observed to make it difficult to observe blood vessels in a lower layer.

Thus, in recent years, an endoscope has been used that performs special light observation with a special light such as an ultraviolet light or a near infrared light instead of normal endoscopic observation with a visible light. With such an endoscope, a near infrared light is used to illuminate an object to be observed to allow observation of a condition in a lower layer than a surface of the object to be observed.

For example, a spectral image observation optical apparatus has been known in which a transmittance characteristic variable element (etalon device) is used to switch wavelength regions of a reflected light from living tissue to split the reflected light into a visible light and fluorescence, thereby obtaining image information on different wavelength regions of the reflected light (for example, see Japanese Patent Application Laid-Open No. 2007-307279).

However, for achieving both normal imaging with a visible light and fluorescence imaging, for example, the apparatus described in Japanese Patent Application Laid-Open No. 2007-307279 requires a special device such as an etalon element. Also, for providing different image pickup devices for a visible light and fluorescence, the plurality of image pickup devices need to be arranged in parallel on a front surface of a distal end of an endoscope, and this makes it difficult to reduce a diameter of the endoscope.

### SUMMARY OF THE INVENTION

The present invention is achieved in view of such circumstances, and has an object to provide an endoscope system that maintains a small diameter of an endoscope (rigid endoscope or flexible endoscope), and can perform both normal imaging with a visible light and fluorescence imaging.

To achieve the object, a first aspect of the present invention provides an endoscope system including: an endoscope inserted into a body cavity for observing a somatoscopy part; a light source that emits an illumination light for illuminating the somatoscopy part; a processor that performs a signal processing of a signal detected by the endoscope to generate an image; and a monitor that displays the image generated by the processor, wherein a plurality of imaging devices that detect a reflected light of the illumination light reflected by the somatoscopy part or an emitted light emitted by the somatoscopy part are arranged in series in a distal end portion of the endoscope, each of the plurality of imaging devices includes a light splitting device that deflects 90° a part of the reflected light or the emitted light and transmits a part of the reflected light or the emitted light and an image pickup device that detects the reflected light or the emitted light deflected 90°, a rearmost imaging device which is rearmostly disposed, of the imaging devices, includes an optical path changing device that deflects 90° the reflected light or the emitted light and an image pickup device that detects the reflected light or the emitted light deflected 90°, and an observation optical member is provided in which the light splitting device and the optical path changing device are arranged in series.

Thus, the plurality of imaging devices are arranged in series to allow imaging in different wavelength regions while maintaining a small diameter of an endoscope.

A second aspect of the present invention is such that the light source includes a visible light source that emits a visible light, and a near infrared light source that emits a near infrared light, two imaging devices are arranged in series, a front imaging device of the two imaging devices includes a light splitting device that deflects 90° the near infrared light and transmits the visible light and an image pickup device having main sensitivity to a near infrared region, and a rear imaging device of the two imaging devices includes an optical path changing device that deflects 90° the visible light having passed through the light splitting device of the front imaging device and an image pickup device having main sensitivity to a visible light region.

This can achieve both normal imaging with a visible light and fluorescence imaging, and increase sensitivity to the visible light and fluorescence by imaging the visible light and the fluorescence with different image pickup devices.

A third aspect of the present invention is such that the light splitting device of the front imaging device is a dichroic prism.

A fourth aspect of the present invention further includes a filter that is provided between the light splitting device of the front imaging device and the image pickup device of the front imaging device and extracts only a near infrared light.

A fifth aspect of the present invention further includes a gain adjustment device of a visible light provided between the light splitting device of the front imaging device and the optical path changing device of the rear imaging device.

This can increase sensitivity to fluorescence, and also allows proper normal imaging with a visible light.

A sixth aspect of the present invention is such that an image pickup device of a frontmost imaging device among the plurality of imaging devices has main sensitivity to an autofluorescence region of a blue light.

Thus, the imaging devices including the image pickup devices having sensitivity to various wavelength regions are arranged in series, thereby allowing imaging in various wavelength regions while maintaining a small diameter of an endoscope.

As described above, according to the present invention, the imaging devices are arranged in series, thereby allowing imaging in different wavelength regions, particularly both normal imaging with a visible light and fluorescence imaging while maintaining a small diameter of an endoscope.

### BRIEF DESCRIPTION OF THE DRAWINGS

FIG. 1 is a schematic configuration diagram of a first embodiment of an endoscope system of the present invention;

FIG. 2 is an enlarged view of an endoscope;

FIG. 3 is a front view of a distal end surface of a distal end portion of an insertion portion;

FIG. 4 is a vertical sectional view of a distal end portion of the endoscope in the first embodiment; and

FIG. 5 is a vertical sectional view of an observation member of a distal end portion of an endoscope of a second embodiment.

### DETAILED DESCRIPTION OF THE PREFERRED EMBODIMENTS

Now, an endoscope system according to the present invention will be described with reference to the accompanying drawings.

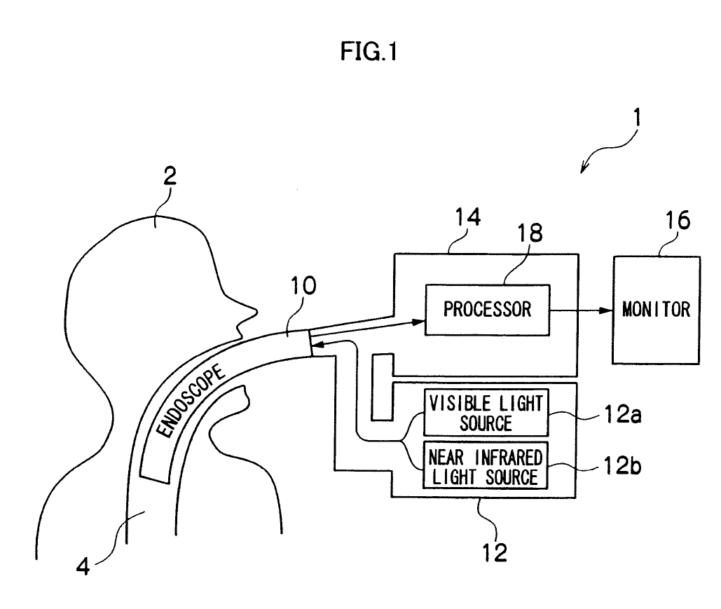

FIG. 1 is a schematic configuration diagram of a first embodiment of an endoscope system of the present invention.

As shown in FIG. 1, an endoscope system 1 of this embodiment includes an endoscope 10 including an imaging device inserted into a body cavity 4 of a patient 2, a light source device 12 that supplies an illumination light to the endoscope 10, a signal processing device 14 that performs processing of a signal from the imaging device of the endoscope 10, and a monitor 16 that displays an image on the basis of an image signal (video signal) outputted from the signal processing device 14.

The endoscope 10 of this embodiment achieves both normal imaging with a visible light and fluorescence imaging as described later in detail. For this purpose, the light source device 12 includes two kinds of light sources: a visible light source 12a and a near infrared light source 12b.

The light source device 12 is not particularly limited, and for example, a xenon lamp exemplifies the visible light source 12a and a semiconductor laser exemplifies the near infrared light source 12b.

The signal processing device 14 converts a signal from the imaging device (CCD) of the endoscope 10 into an image signal, performs predetermined image processing and outputs the image signal, and includes a processor 18 that performs the image processing.

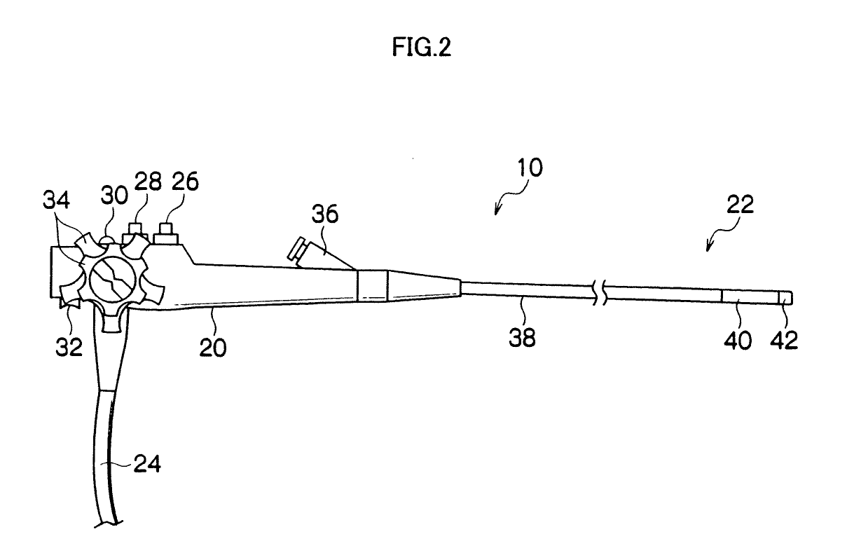

FIG. 2 shows the endoscope 10 enlarged.

As shown in FIG. 2, the endoscope 10 mainly includes a hand operation portion 20 and an insertion portion 22 connected to the hand operation portion 20, and an universal cable 24 is connected to the hand operation portion 20. In a distal end of the universal cable 24, a connector (not shown) connected to the processor 18 and the light source device 12 is provided.

On the hand operation portion 20, an air/water feeding button 26, a suction button 28, a shutter button 30, a seesaw switch 32 for zoom operation, angle knobs 34 and 34, and a forceps insertion portion 36 are provided.

The insertion portion 22 includes a flexible portion 38, a bending portion 40, and a distal end portion 42. The bending portion 40 is remotely bent by rotating the pair of angle knobs 34 and 34 provided on the hand operation portion 20. This allows a distal end surface of the distal end portion 42 to be oriented in a desired direction.

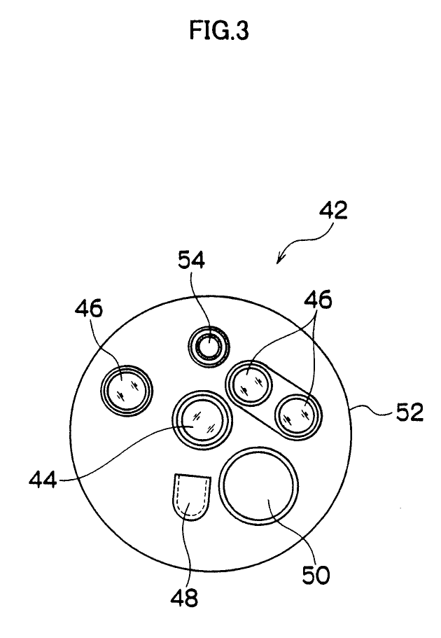

FIG. 3 shows the distal end surface of the distal end portion 42 of the insertion portion 22.

As shown in FIG. 3, in the distal end surface of the distal end portion 42, an observation optical member 44, illumination members 46 and 46, an air/water feeding nozzle 48, and a forceps channel (forceps opening) 50 are provided. A cap 52 is secured and mounted to the distal end surface by a screw 54. The observation optical member 44 is located substantially at the center of the distal end surface, and the illumination members 46 and 46 are provided on lateral sides of the observation optical member 44.

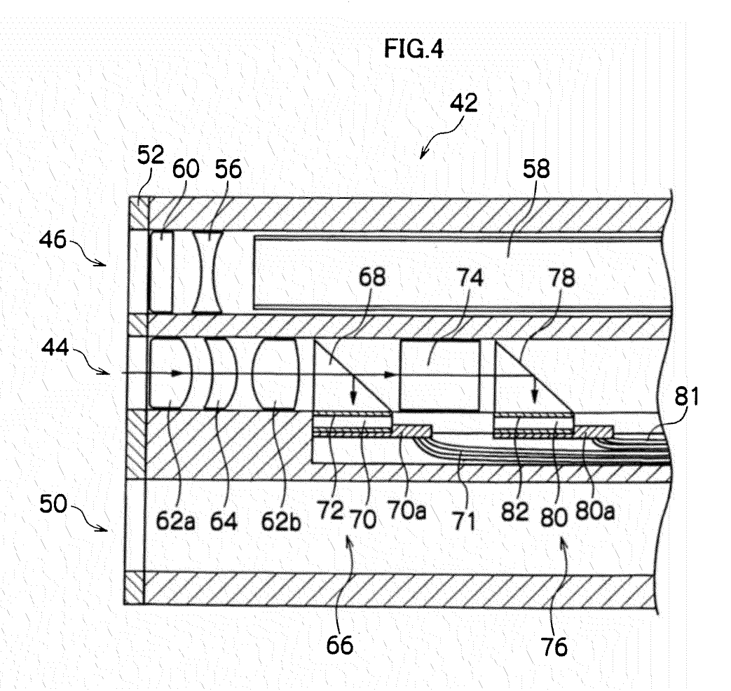

FIG. 4 is a vertical sectional view of the distal end portion 42 of the endoscope 10 in the first embodiment.

As shown in FIG. 4, in the distal end portion 42, the observation optical member 44, the illumination member 46, and the forceps channel (forceps opening) 50 are provided.

The illumination member 46 includes an illumination lens 56 that is an optical system that diffuses an illumination light, and a light guide 58 that transmits the illumination light from the light source device 12 to the illumination lens 56. Thus, the illumination light from the light source device 12 is emitted via the light guide 58 and the illumination lens 56 from an illumination window 60 in which a cover glass of the distal end surface of the distal end portion 42 is fitted.

In FIG. 4, only one light guide or the like is shown, but actually, one light guide or the like is provided for each of the visible light source 12a and the near infrared light source 12b.

The observation optical member 44 includes fixed lenses 62a and 62b and a movable lens 64 on a side of the distal end surface. In FIG. 4, each of these lenses is shown as one lens, but is actually formed as a lens group including a plurality of lenses.

A first imaging device 66 that performs fluorescence imaging is provided behind the fixed lens 62b. The first imaging device 66 includes a dichroic prism 68 as a light splitting device that deflects 90° a near infrared light that excites fluorescence and transmits a visible light among lights incident on the observation optical member 44, and an image pickup device (CCD) 70 that is provided below the dichroic prism 68 and images a fluorescence image excited by the near infrared light.

The CCD 70 is housed in and connected to a CCD package 70a in which a wiring pattern is formed, and a signal wire 71 for connection to the outside is connected to the CCD package 70a via the wiring pattern.

A filter 72 for allowing extraction of only a near infrared light is provided between the dichroic prism 68 and the CCD 70. The filter 72 may be a band-pass filter that transmits only a near infrared light or a short wavelength cut filter (long-pass filter) that cuts visible lights of, for example, 820 nm or less. The filter 72 preferably can cut lights of wavelengths substantially 20 nm or less from a fluorescence wavelength excited by a near infrared light by four digits or more in percentage.

When the filter 72 thus can extract only a near infrared light of about 800 nm, a simple beam splitter may be used instead of the dichroic prism 68.

As such, by extracting only the near infrared light to be incident on the CCD 70, the CCD 70 detects fluorescence excited by the near infrared light. Further, the CCD 70 preferably has higher sensitivity to the near infrared light than a normal image pickup device.

An optical system 74 is provided behind the dichroic prism 68. The optical system 74 has a visible light gain adjustment function for attenuating an amount of visible light from an illumination light illuminated by the first imaging device 66 with high intensity for feeble fluorescence imaging to an amount of light suitable for sensitivity of a second imaging device described later that performs normal imaging with a visible light. Such a visible light attenuation optical system may be an optical module or the like that can adjust intensity of a visible light, for example, an ND filter or an iris.

The optical system 74 includes a lens group for adjusting an optical path length for achieving focus in both the first imaging device 66 and the second imaging device described later. As such an optical path length adjustment lens, a relay lens is suitably used.

If the dichroic prism 68 can split a light into a near infrared light and a visible light so that an amount of the near infrared light is larger, there is no need for the gain adjustment of the visible light by the above described optical system 74.

A second imaging device 76 is provided behind the optical system 74. The second imaging device 76 includes a prism 78 as an optical path changing device that deflects 90° a visible light incident on the observation optical member 44 and having passed through the dichroic prism 68 and the optical system 74, and an image pickup device (CCD) 80 that is provided below the prism 78 and performs normal imaging with a visible light.

The CCD 80 is housed in and connected to a CCD package 80a in which a wiring pattern is formed, and a signal wire 81 for connection to the outside is connected to the CCD package 80a via the wiring pattern.

A filter 82 such as an IR cut filter is provided between the prism 78 and the CCD 80. The prism 78 may be a simple mirror.

In the embodiment, the CCD 70 of the first imaging device 66 that performs fluorescence imaging with a near infrared light is a monochrome CCD, and the CCD 80 of the second imaging device 76 that performs normal imaging with a visible light is a color CCD.

Particularly, the CCD 70 of the first imaging device 66 that performs the fluorescence imaging may have low resolution by increasing a pixel size and higher sensitivity to the near infrared light than a normal light by increasing an aperture.

An operation of the endoscope system 1 of this embodiment configured as described above will be described below.

First, the distal end portion 42 of the endoscope 10 is inserted into the body cavity of the patient, and a fluorescence drug, for example, indocyanine green excited by an excitation light having a wavelength emitted by a semiconductor laser of the near infrared light source 12b is locally injected around a site to be observed through the forceps opening 50.

The visible light source 12a applies a visible light to the site to be observed, and the near infrared light source 12b applies a near infrared light thereto.

A near infrared light that is an excitation light passes through living tissue and is absorbed by indocyanine green accumulated in the living tissue, and near infrared fluorescence is emitted.

A reflected light of the visible light applied to the site to be observed and the near infrared fluorescence emitted from the living tissue are together incident on the observation optical member 44.

The light incident on the observation optical member 44 is split into near infrared fluorescence and a visible light by the dichroic prism 68.

An optical path of the near infrared fluorescence is deflected 90° by the dichroic prism 68, and an image of the near infrared fluorescence is focused as a near infrared fluorescence image on an incident surface of the CCD 70 of the first imaging device 66 via the filter 72.

The near infrared light image detected by the CCD 70 is converted into an electric signal and transmitted to the processor 18 via the signal wire 71. The processor 18 performs signal processing (image processing) of the signal to generate a fluorescence image (gradation image of fluorescence image) and display the image on the monitor 16.

The visible light having passed through the dichroic prism 68 is subjected to visible light gain adjustment and optical path length adjustment by the optical system 74 and is then incident on the prism 78.

An optical path of the visible light incident on the prism 78 is deflected 90° by the prism 78, and an image of the visible light is focused as a normal image on an incident surface of the CCD 80 of the second imaging device 76 via the filter 82.

The normal image of the visible light detected by the CCD 80 is converted into an electric signal and transmitted to the processor 18 via the signal wire 81. The processor 18 performs signal processing (image processing) of the signal to generate a normal image (color image of normal image) and display the image on the monitor 16.

As such, an observer can observe both the normal image with the visible light and the fluorescence image with the near infrared light.

Particularly, in this embodiment, the prisms 68 and 78 that deflect 90° the optical paths are used to arrange the first imaging device 66 and the second imaging device 76 in series, thereby allowing both normal imaging and fluorescence imaging while maintaining a small diameter of an endoscope (rigid endoscope or flexible endoscope).

In the above described embodiment, the two imaging devices are arranged in series to achieve both the normal imaging and the fluorescence imaging, but the number of the imaging devices arranged in series is not limited to two, and three or more imaging devices may be arranged in series.

Next, a second embodiment of the present invention will be described. In the second embodiment, three imaging devices are arranged in series to allow fluorescence imaging with autofluorescence in a blue wavelength region, fluorescence imaging with near infrared fluorescence, and normal imaging with a visible light.

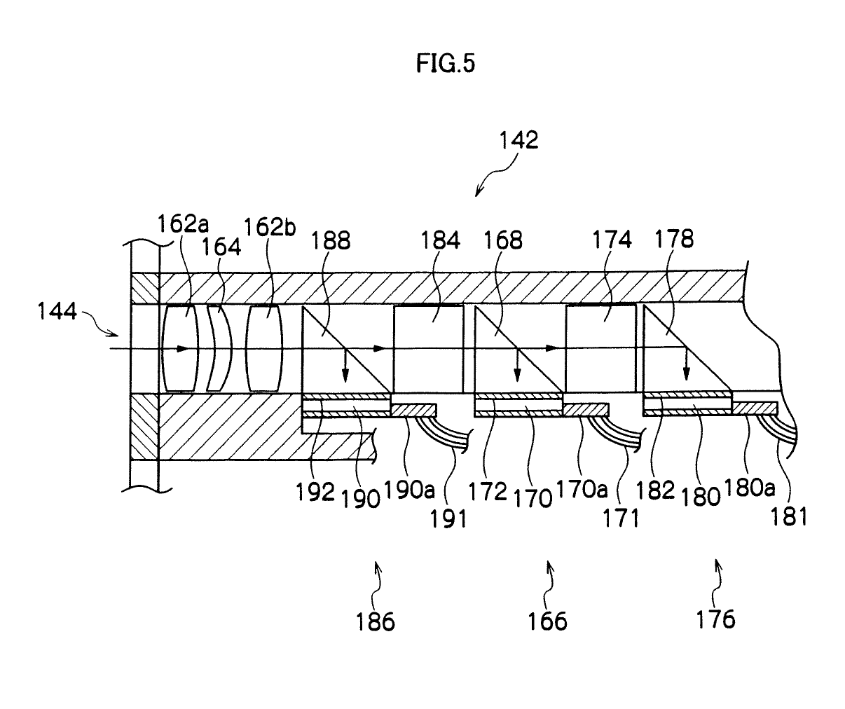

FIG. 5 shows an observation optical member 144 in a distal end portion 142 of an endoscope of an endoscope system of the second embodiment.

As shown in FIG. 5, the observation optical member 144 in the second embodiment includes a third imaging device that is provided between the fixed lenses 62a and 62b and movable lens 62 and the first imaging device 66 in the first embodiment and performs fluorescence imaging with autofluorescence in a blue wavelength region.

Specifically, the observation optical member 144 in this embodiment includes a fixed lens 162a, a movable lens 164, a fixed lens 162b, then a third imaging device 186 that images autofluorescence, a first imaging device 166 that images near infrared fluorescence, and a second imaging device 176 that performs normal imaging of a visible light, arranged in series from a side of a distal end surface (left side in FIG. 5).

The third imaging device 186 includes a prism 188 that deflects 90° a blue light that excites autofluorescence and transmits the other lights among lights incident on the observation optical member 144, and an image pickup device (CCD) 190 that is provided below the prism 188 and images the autofluorescence excited by the blue light.

The CCD 190 is housed in and connected to a CCD package 190a in which a wiring pattern is formed, and a signal wire 191 for connection to the outside is connected to the CCD package 190a via the wiring pattern.

A filter 192 for allowing extraction of a blue light is provided between the prism 188 and the CCD 190. The filter 192 may be, for example, a long wavelength cut filter that cuts lights having long wavelengths and extracts only a blue light.

The first imaging device 166 and the second imaging device 176 are the same as in the first embodiment. Specifically, the first imaging device 166 includes a dichroic prism 168 that deflects 90° a near infrared light that excites fluorescence and transmits a visible light among lights incident on the observation optical member 144, and an image pickup device (CCD) 170 that is provided below the dichroic prism 168 and images a fluorescence image excited by the near infrared light.

The CCD 170 is housed in and connected to a CCD package 170a in which a wiring pattern is formed, and a signal wire 171 for connection to the outside is connected to the CCD package 170a via the wiring pattern.

A filter 172 for allowing extraction of only a near infrared light is provided between the dichroic prism 168 and the CCD 170.

The second imaging device 176 includes a prism 178 that deflects 90° a visible light incident on the observation optical member 144 and having passed through the dichroic prism 168, and an image pickup device (CCD) 180 that is provided below the prism 178 and performs normal imaging with a visible light.

The CCD 180 is housed in and connected to a CCD package 180a in which a wiring pattern is formed, and a signal wire 181 for connection to the outside is connected to the CCD package 180a via the wiring pattern. A filter 182 such as an IR cut filter is provided between the prism 178 and the CCD 180.

An optical system 174 for visible light gain adjustment and optical path length adjustment is provided between the dichroic prism 168 of the first imaging device 166 and the prism 178 of the second imaging device 176, and an optical system 184 for optical path length adjustment is provided between the prism 188 of the third imaging device 186 and the dichroic prism 168 of the first imaging device 166.

When the third imaging device 186 performs fluorescence imaging with autofluorescence, a blue light is split from the visible light emitted from the visible light source 12a by the prism 188, and an optical path of the blue light is deflected 90° to be incident on the CCD 190 via the filter 192. Thus, autofluorescence with the blue light is detected.

Also, fluorescence imaging with near infrared fluorescence and normal imaging with a visible light may be performed in the same manner as in the above described first embodiment.

As such, the plurality of imaging devices that detect different lights are arranged in series, thereby allowing images in different wavelength regions to be imaged while maintaining a small diameter of an endoscope.

The endoscope system of the present invention is described as above, but it is to be understood that the present invention is not limited to the above embodiments and various changes or modifications may be made without departing from the gist of the present invention.

What is claimed is:

1. An endoscope system comprising:
an endoscope inserted into a body cavity for observing a somatoscopy part;
a light source that emits an illumination light for illuminating the somatoscopy part;
a processor that performs signal processing of a signal detected by the endoscope to generate an image; and
a monitor that displays the image generated by the processor,
wherein a plurality of imaging devices that detect a reflected light of the illumination light reflected by the somatoscopy part or an emitted light emitted by the somatoscopy part are arranged in series in a distal end portion of the endoscope,
each of the plurality of imaging devices includes a light splitting device that deflects 90° a part of the reflected light or the emitted light and transmits a part of the reflected light or the emitted light and an image pickup device that detects the reflected light or the emitted light deflected 90°,
a rearmost imaging device which is rearmostly disposed, of the imaging devices, includes an optical path changing device that deflects 90° the reflected light or the emitted light and an image pickup device that detects the reflected light or the emitted light deflected 90°, and
an observation optical member is provided in which the light splitting device and the optical path changing device are arranged in series.

2. The endoscope system according to claim 1, wherein the light source includes a visible light source that emits a visible light, and a near infrared light source that emits a near infrared light,
two imaging devices are arranged in series, a front imaging device of the imaging devices includes a light splitting device that deflects 90° the near infrared light and transmits the visible light and an image pickup device having main sensitivity to a near infrared region, and a rear imaging device of the two imaging devices includes an optical path changing device that deflects 90° the visible light having passed through the light splitting device of the front imaging device and an image pickup device having main sensitivity to a visible light region.

3. The endoscope system according to claim 2, wherein the light splitting device of the front imaging device is a dichroic prism.

4. The endoscope system according to claim 2, further comprising: a filter that is provided between the light splitting device of the front imaging device and the image pickup device of the front imaging device and extracts only a near infrared light.

5. The endoscope system according to claim 2, further comprising: a gain adjustment device of a visible light provided between the light splitting device of the front imaging device and the optical path changing device of the rear imaging device.

6. The endoscope system according to claim 3, further comprising: a gain adjustment device of a visible light provided between the light splitting device of the front imaging device and the optical path changing device of the rear imaging device.

7. The endoscope system according to claim 4, further comprising: a gain adjustment device of a visible light provided between the light splitting device of the front imaging device and the optical path changing device of the rear imaging device.

8. The endoscope system according to claim 1, wherein an image pickup device of a frontmost imaging device among the plurality of imaging devices has main sensitivity to an autofluorescence region of a blue light.
